(19) United States
(12) Patent Application Publication
(10) Pub. No.: US 2018/0192264 A1
(43) Pub. Date: Jul. 5, 2018

(54) Open Access Points for Emergency Calls

(71) Applicant: T-Mobile USA, Inc., Bellevue, WA (US)

(72) Inventors: Ming Shan Kwok, Seatle, WA (US); Hsin-Fu Henry Chiang, Bellevue, WA (US)

(21) Appl. No.: 15/395,334

(22) Filed: Dec. 30, 2016

(51) Int. Cl. H04W 4/22; H04W 12/06

(52) U.S. Cl. CPC H04W 4/22; H04W 84/12; H04W 12/06

(57) ABSTRACT

The systems, devices, and techniques described herein are directed to providing access to private or restricted access points to facilitate emergency calls. A Wi-Fi access point installed in a home environment of a user may be secured via a password or encryption, or may otherwise be restricted to provide access only to user equipment that is authorized to access the access point. The access point may include an emergency access module to provide limited access to an otherwise unauthorized user equipment to access the access point in during an emergency. The access point may determine that a user equipment is unauthorized and that the user equipment is attempting to establish an emergency call to a public-safety answering point. In such a case, the access point may provide limited access to the user equipment for the purpose of making the emergency call.

### BACKGROUND

Modern telecommunication systems include heterogeneous mixtures of second, third, and fourth generation (2G, 3G, and 4G) cellular-wireless access technologies, which may be cross-compatible and may operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies.

Further, wireless devices often may supplement cellular coverage with connectivity provided by Wi-Fi access points, such as in a home environment. However, Wi-Fi access points are often protected by a password or encryption, and are not available for public use. Thus, if a person or wireless device is not authorized to connect to the access point, the access point may not facilitate voice or data transfer, regardless of the circumstances.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment for facilitating open access to a Wi-Fi access point to facilitate emergency calls.

FIG. 2 illustrates an example access point configured to provide open access to user equipment for emergency calls.

FIG. 3 illustrates an example centralized server configured to provide authentication and facilitate operation of open access points to provide emergency calls.

FIG. 4 illustrates an example user equipment for initiating an emergency call via an open access point of the present disclosure.

FIG. 5 illustrates an example process for providing an open access point for emergency calls.

FIG. 6 illustrates an example process for verifying credentials associated with user equipment during an emergency call.

FIG. 7 illustrates an example process for establishing an emergency call on an open access point in accordance with the present disclosure.

### DETAILED DESCRIPTION

The systems, devices, and techniques described herein are directed to providing access to private or restricted access points to facilitate emergency calls. For example, an access point may include a Wi-Fi access point installed in a home environment of a user. The Wi-Fi access point (also referred to as an access point) may be secured via a password or encryption, or may otherwise be restricted to provide access only to user equipment that is authorized to access the access point. However, the access point may include an emergency access module, which may provide limited access to an otherwise unauthorized user equipment to access the access point in during an emergency. For example, the access point may determine that a user equipment is unauthorized and that the user equipment is attempting to establish an emergency call to a public-safety answering point (PSAP). In such a case, the access point may provide limited access to the user equipment and may facilitate the emergency call, regardless of whether the user equipment is otherwise authorized to access the access point. Thus, the access point may provide open access to emergency calls, thereby greatly improving access to emergency resources.

In some instances, the access point can provide immediate access to user equipment upon receiving a request from the user equipment to initiate an emergency call. For example, a request for an emergency call can include a destination associated with an emergency call, such as a PSAP. In some instances, the request may include an indication that the request is directed to an emergency call (e.g., a flag, token, or field indicating an emergency call). In some instances, the access point can provide an indication to user equipment that the user equipment is not authorized to access a network via the access point. Further, the access point can request credentials from the user equipment and provide the credentials to a centralized server to verify an identity of the user equipment or to authenticate the user equipment for limited network access. The access point may determine that a communication is an emergency call based on a destination of the request for communication as one of many public-safety answering points (PSAPs), and may provide limited access to the requesting user equipment. As mentioned above, in some instances, the request may include a flag, token, or field indicating that the request is directed to an emergency call. In some instances, the access point may allocate bandwidth to the emergency call to ensure that bandwidth is available despite a presence of other devices utilizing a network. In some instances, the access point may block access to other devices or addresses on the network to limit an exposure of devices to malicious activity, or to prevent abuse of the open access architecture.

A centralized server may operate in conjunction with the access point to authenticate an identity or credentials associated with user equipment, and to instruct an access point to provide open access for emergency calls. For example, the centralized server may verify that a user equipment is subscribed to operate on a particular network, and may grant access to the access point on the basis of that subscription. In some instances, the access point can forward emergency calls to the centralized server, where the centralized server can route the emergency calls to one or more public-safety answering points. In some instances, the centralized server can provide additional filtering or inspection of traffic requests to determine whether a communication is outside a scope of an emergency call (e.g., the emergency call has masked malicious activity or unnecessary data services, for example).

A user equipment can include functionality to determine that an access point is protected, private, secure, or otherwise restricted, and may attempt to establish a connection using the open access architecture described herein. That is, rather than ignoring the protected or secured access point, the user equipment can utilize the access point for an emergency call, where the user equipment would otherwise be unable to establish a communication with the access point. For example, a user equipment may determine that a communication request is an emergency call, and override any operations to request a communication channel from the access point, which would otherwise be denied.

In this manner, the systems, devices, and techniques described herein improve a functioning of a computing device by facilitating a network communication. For example, an open access point can provide access to a network during an emergency scenario to facilitate emergency calls whereby a connection would otherwise be denied. Thus, the open access point architecture described herein can facilitate network security under normal circumstances, but can provide open access to otherwise unauthorized devices in an emergency. In some instances, the architecture expands a scope of coverage for emergency access for locations which would otherwise not have coverage (outside of private Wi-Fi access points). Further, congestion in a network can be reduced by denying access to devices that are not authorized to utilize a particular network and by limiting a destination of data to destinations associated with an emergency call. By providing a wireless communication in emergency situations, emergency responders can be deployed at critical times.

The systems, devices, and techniques described herein can be implemented in a number of ways. Although aspects of this disclosure may be discussed in context of an emergency call (e.g., a call that is directed to, associated with, or is routed through a public-safety answering point (PSAP)), the disclosure applies to other wireless communications as well, and is not intended to be limited to one particular context. Example implementations are provided below with reference to the following figures.

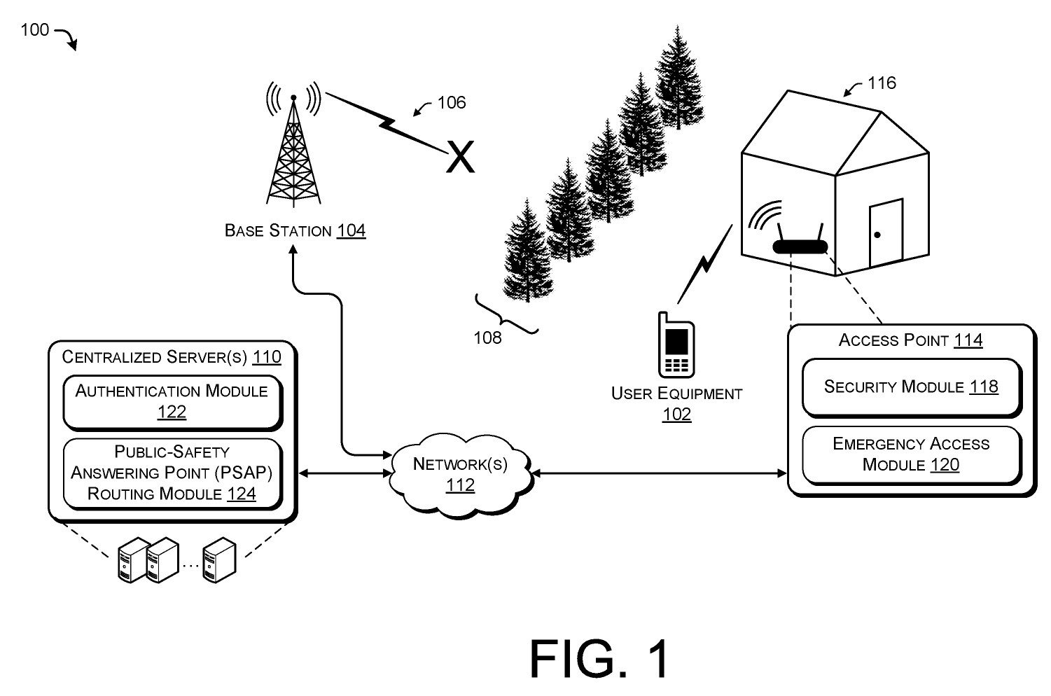

FIG. 1 illustrates an example environment 100 for facilitating open access to a Wi-Fi access point to facilitate emergency calls. In some instances, the environment 100 can include user equipment 102 (e.g., a smartphone) that is out of range of a base station 104, and thus cannot receive a signal 106 because the signal 106 is blocked by one or more obstructions 108. As illustrated, the obstructions 108 are represented by trees, although it may be understood in the context of this disclosure that any number of reasons may contribute to the inability of the user equipment 102 to establish a communication with the base station 104. In some instances, the base station 104 provides wireless access to one or more centralized server(s) 110 via one or more network(s) 112 (e.g., the Internet). In some instances, the user equipment 102 may be configured to communicate with the centralized server(s) 110 (or other user equipment, servers, or devices) via the base station 104. For example, the base station 104 may be associated with a network that the user equipment 102 is associated with (e.g., by contract or subscription), such that the base station 104 is a default network for communications with the user equipment 102.

The environment 100 further includes an access point 114 located in a home 116 or office, for example. In some instances, the access point 114 includes a security module 118 that restricts access to the access point 114, such that the access point 114 provides access only to authorized users or user equipment. For example, the access point 114 may provide access to the network(s) 112 to one or more devices that are connected to the access point 114. For example, the home 116 may include any number of devices capable of (and authorized for) connecting to the access point 114. For example, the security module 118 may verify a password provided by authorized user equipment to access the access point 114, or may otherwise protect, secure, or restrict access to the access point 114.

In some instances, the security module 118 may deny access to the access point 114. However, in the event that the user equipment 102 (e.g., an unauthorized user equipment, with respect to the access point 114) attempts to establish an emergency call, an emergency access module 120 may provide access to the user equipment 102 to facilitate a communication with a public-safety answering point, for example.

The access point 114 may provide access to the user equipment 102 in at least two ways, when the user equipment 102 is not authorized by the security module 118 to communicate via the access point 114. In some instances, the access point 114 may request credentials associated with the user equipment 102 and may provide such credentials to an authentication module 122 associated with the centralized server(s) 110. In some instances, a credential associated with the user equipment 102 may include, but is not limited to, one or more of SIM (subscriber identity module) information, a telephone number, MAC (media access control) address, IP (Internet protocol) address, an email address, IMEI (international mobile equipment identity) number, etc.

In some instances, the authentication module 122 of the centralized server(s) 110 may receive one or more credentials associated with the user equipment 102 and, based on those credentials, may determine that the user equipment 102 has some relationship (e.g., contractual or subscriber-based relationship) with the centralized server(s) 110, such that the authentication module 122 may instruct the access point 114 to provide access to the user equipment 102. In some instances, the access provided by the access point 114 may be limited to facilitating an emergency call, may be restricted to voice calls only, may be limited to particular destinations, may be restricted or limited by bandwidth or communication duration, may be unrestricted, etc.

In some instances, the user equipment 102 may not provide credentials to the access point 114 and/or the centralized server(s) 110. For example, the user equipment 102 may not be associated with a SIM card, or may not be activated to operate on a particular network. In any event, the user equipment 102 may request access from the access point 114 for an emergency call. Upon receiving the emergency call request from the user equipment 102, the emergency access module 120 of the access point 114 can determine the type of communication request (e.g., an emergency call) and can provide access to the user equipment 102. In some instances, the emergency access module 120 may request confirmation from the centralized server 110 that the communication request is directed to a valid emergency call. In some instances, the emergency access module 120 may route an emergency call to a public-safety answering point (PSAP) routing module 124 associated with the centralized server(s) 110, whereby the PSAP routing module 124 may route the communication to an appropriate emergency destination. In some instances, the emergency access module 120 may route an emergency call directly to the PSAP without using the centralized server(s) 110 as an intermediate point.

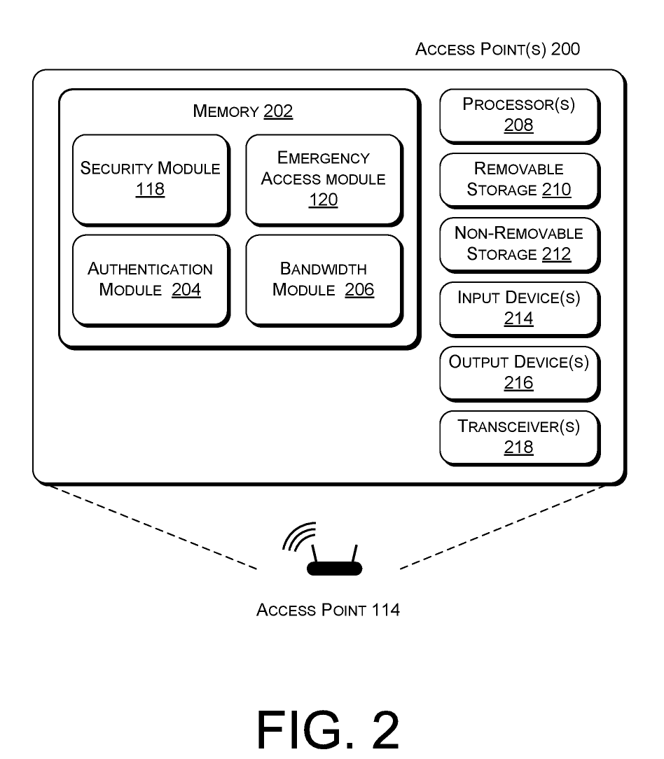

Additional aspects of the user equipment 102, the centralized server(s) 110, and the access point 114 are discussed in connection with FIGS. 2-7, below.

FIG. 2 illustrates an example access point 200 configured to provide open access to user equipment for emergency calls. In some embodiments, the access point 200 can correspond to the access point 114 of FIG. 1, and may be used to implement the various operations described herein. As discussed herein, the access point 114 may be deployed in a variety of environments and facilitate wireless communication using a variety of protocols. For example, the access point 114 may be a Wi-Fi access point located in a home or office of a user to provide access to connected devices to the Internet to generate, request, receive, transmit, or exchange voice, video, and/or digital data. In some instances, the access point 114 may provide 2G, 3G, 4G, and/or LTE connectivity to one or more wireless devices.

As illustrated, the access point 200 comprises a memory 202 storing the security module 118, the emergency access module 120, an authentication module 204, and a bandwidth module 206. Also, the access point 200 includes processor(s) 208, a removable storage 210 and non-removable storage 212, input device(s) 214, output device(s) 216, and transceiver(s) 218.

In various embodiments, the memory 202 is volatile (such as RAM), non-volatile (such as ROM, flash memory, etc.) or some combination of the two. The security module 118, the emergency access module 120, the authentication module 204, and the bandwidth module 206 stored in the memory 202 can comprise methods, threads, processes, applications or any other sort of executable instructions. The security module 118, the emergency access module 120, the authentication module 204, and the bandwidth module 206 can also include files and databases.

Details of the security module 118 and the emergency access module 120 are provided above in the discussion of FIG. 1. Further to the discussion above, the security module 118 can include functionality to enable Wired Equivalent Privacy (WEP) and Wi-Fi Protected Access (WPA). In some instances, the access point 114 may broadcast a SSID (service set identifier) that may require one or more passwords, passcodes, authentication, encryption keys, etc. to gain full access to the access point 200. In some instances, the security module 118 may implement encryption and/or access controls such as WPA2-PSK (Wi-Fi Protected Access 2, Pre-Shared Key), AES (Advanced Encryption Standard), etc. In some instances, the security module 118 may provide additional types of security protection, including but not limited to, open (e.g., no security or authentication), open with URL (uniform resource locator) redirection (e.g., requesting consent and/or username and password to access the access point 114), etc. In some instances, the security module 118 may include filters and/or firewalls to prevent unauthorized access to the access point 200. In some instances, the security module 118 may be selectively enabled or disabled to provide restricted or unrestricted access available to any user equipment.

In some instances, the access point 200 may broadcast one or more SSIDs associated with various security levels and access levels to network resources. For example, the access point 200 may broadcast a first SSID associated with the security module 118 such that a password, encryption key, or authorization is required to connect to the access point 200. In some instances, this first SSID may provide unlimited access to network resources for a user equipment connected to the access point 200 via the first SSID. The access point 200 may further broadcast a second SSID associated with the emergency access module 120, such that any user equipment may connect to the second SSID to conduct an emergency call. For example, the second SSID may be associated with a limited set of network resources, such that the second SSID may facilitate an emergency call and transmit data to destinations associated with a public-safety answering point. In some instances, the access point 200 broadcasts only one SSID and may determine to grant limited access for an emergency call on an ad hoc basis. In some instances, one or all SSIDs may be public or hidden.

In addition to the description above, in some instances, the emergency access module 120 can include functionality to determine that a request from a user equipment (that is not authorized by the security module 118) is directed to an emergency call destination, such as a PSAP. In some instances, the emergency access module 120 may operate in conjunction with other modules, such as the authentication module 204, to determine that a requested destination is an emergency destination and/or that a user equipment is authorized to access a network on some level. For example, in some instances, a request from a user equipment to initiate a call may include a flag, token, or field indicating that the request is directed to an emergency call. In one implementation, the security module 118 may receive the request, determine that the request is directed to an emergency call, and forward the request to the emergency access module 120 to provide immediate access to the requesting user equipment, without requiring authorization or verification by the security module 118. In some instances, the emergency access module 120 may provide limited functionality to an emergency call, as described herein.

In some embodiments, the authentication module 204 can include functionality to determine an authenticity of one or more credentials associated with a user equipment and/or to determine an authenticity of an emergency request directed to the access point 114. For example, the authentication module 204 can request identification information associated with the user equipment (e.g., the user equipment 102), such as a telephone number, device ID, email address, MAC address, IMEI number, SIM card identifier, IP address, etc. The authentication module 204 can query a centralized server (e.g., the centralized server 110) to verify that a user equipment is associated with a particular network or provider, or has a contractual relationship with an entity or is a subscriber to a network plan. The authentication module 204 can allow or deny partial or complete access to the access point 200 based at least in part on the results of an authentication by the authentication module 204.

Further, the authentication module 204 may authenticate that a destination associated with an emergency call request is actually associated with an emergency call destination, such as a public-safety answering point (PSAP). For example, the authentication module 204 may transmit a message to the centralized server 110 and/or a PSAP to verify that a communication destination is, in fact, an emergency call destination, to prevent the emergency access module 120 from being misused to provide voice or data access where otherwise such access would be denied (e.g., to a user equipment not authorized by the security module 118). In some instances, the authentication module 204 may communicate with the authentication module 122 in the centralized server(s) 110 to authenticate a communication and/or user device in accordance with embodiments of the disclosure.

In some embodiments, the bandwidth module 206 can include functionality to allocate at least a portion of bandwidth of the access point 200 to providing the emergency call. For example, the access point 200 may have a finite bandwidth allocated to the access point, such as 1 Mbps (megabits per second), 5 Mbps, 10 Mbps, etc., and a number of devices requesting bandwidth may be high, or some or all of the bandwidth may be allocated to other user equipment. In some instances, the bandwidth module 206 may allocate a minimum (or maximum) portion of bandwidth to a user equipment requesting access for an emergency call. In some instances, the bandwidth module 206 may guarantee a minimum level of QoS (Quality of Service), reflecting a particular bandwidth, latency, number of dropped packets, etc. associated with the communication.

In some embodiments, the processor(s) 208 is one or more central processing units (CPUs), graphics processing units (GPUs), or both CPU and GPU, or other processing units or components known in the art.

The access point 200 also includes additional data storage devices (removable and/or non-removable) such as, for example, magnetic disks, optical disks, or tape. Such additional storage is illustrated in FIG. 2 by removable storage 210 and non-removable storage 212. Tangible computer-readable media can include volatile and nonvolatile, removable and non-removable media implemented in any method or technology for storage of information, such as computer readable instructions, data structures, program modules, or other data. Memory 202, removable storage 210, and non-removable storage 212 are all examples of computer-readable storage media. Computer-readable storage media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by the access point 200. Any such tangible computer-readable media can be part of the access point 200.

The access point 200 can include input device(s) 214, such as a keypad, a cursor control, a touch-sensitive display, image sensors, etc. Also, the access point 200 can include output device(s) 216, such as a display, speakers, haptic feedback, printers, etc. These devices are well known in the art and need not be discussed at length here.

As illustrated in FIG. 2, the access point 200 can include one or more wired or wireless transceiver(s) 218. In some wireless embodiments, to increase throughput, the transceiver(s) 218 can utilize multiple-input/multiple-output (MIMO) technology. The transceiver(s) 218 can be any sort of wireless transceivers capable of engaging in wireless, radio frequency (RF) communication. For example, the transceiver(s) 218 can implement one or more technologies including Wi-Fi, 2G, 3G, 4G, LTE, LTE-U (LTE in unlicensed spectrum), Bluetooth, Bluetooth Low Energy, LoRa, WirelessHD, WiGig, Z-Wave, Zigbee, AM/FM, RFID, NFC, satellite radio, satellite phone, etc. Thus, the transceiver(s) 218 can implement GSM, UMTS, and/or LTE/LTE Advanced telecommunications technologies using terrestrial or satellite transceivers.

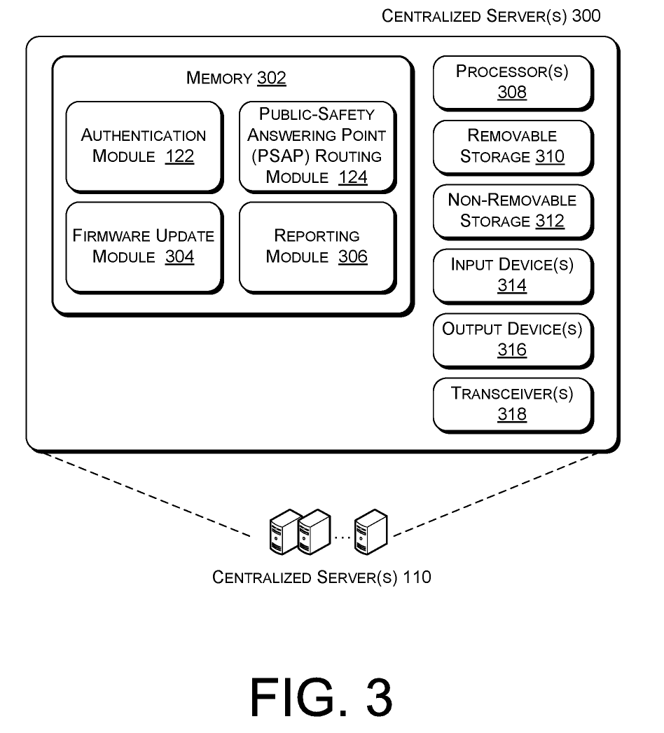

FIG. 3 illustrates an example centralized server 300 configured to provide authentication and facilitate operation of open access points to provide emergency calls. In some embodiments, the centralized server 300 can correspond to the centralized server(s) 110 of FIG. 1, and may be used to implement the various operations described herein. It is to be understood in the context of this disclosure that the centralized server 300 can be implemented as a single device or as a plurality of devices with modules and data distributed among them. For example, the centralized server may include memory 302 storing the authentication module 122, the public-safety answering point (PSAP) routing module 124, a firmware update module 304, and a reporting module 306, as described herein. Also, the centralized server 300 includes processor(s) 308, a removable storage 310 and non-removable storage 312, input device(s) 314, output device(s) 316, and transceiver(s) 318.

In various embodiments, memory 302 is volatile (such as RAM), non-volatile (such as ROM, flash memory, etc.) or some combination of the two. The authentication module 122, the public-safety answering point (PSAP) routing module 124, the firmware update module 304, and the reporting module 306 stored in the memory 302 can comprise methods, threads, processes, applications or any other sort of executable instructions. The authentication module 122, the public-safety answering point (PSAP) routing module 124, the firmware update module 304, and the reporting module 306 can also include files and databases.

Details of the authentication module 122 and the PSAP routing module 124 are provided above in the discussion of FIG. 1. In general, the authentication module 122 may include functionality to verify credentials associated with a user equipment requesting access to an access point, for example. The authentication module 122 may receive credentials from the access point and compare the credentials against a database of information to identify if a user equipment is associated with a particular network provider, subscription service, contract, etc. Further, the authentication module 122 may receive a destination associated with a request for an emergency call and verify or authenticate whether the destination is a valid destination for an emergency call. Turning to the PSAP routing module 124, this module may include functionality to receive a request for an emergency call and route the call to an appropriate public-safety answering point. In some instances, the PSAP module can coordinate with the authentication module 122 to determine whether a destination is a valid PSAP destination. In some instances, the PSAP routing module 124 (and/or the authentication module 122) can provide an indication to the access point, indicating whether the access point should allow access to a user equipment to make an emergency call.

In some embodiments, the firmware update module 304 can include functionality to download programs, applications, or to update operations on an access point (e.g., the access point 114 or 200) to configure the access point 114 to provide open access, as described herein. Thus, the centralized server 200 may retroactively update a firmware associated with the emergency access module 120, and in some instances, the firmware update module 304 may provide the emergency access module 120 to any access point, for example. In some instances, the centralized server 200 may update preconditions, rules, SSIDs, etc. indicating when an access point should allow access for emergency call, for example.

In some embodiments, the reporting module 306 can provide functionality to receive reports and/or historical call data of emergency calls from user equipment to optimize the open access for emergency calls. For example, after each emergency call is placed, user equipment can provide a log of all activity associated with the emergency call, including location of the user equipment (or whether location information was available or not available), QoS of network(s), call flows (e.g., order of initiating a communication with networks, timeouts, retries, success/failure of connections, etc.) to the centralized server 300. The reporting module 306 can receive and aggregate the activity logs to determine if additional network devices (e.g., base stations) can be deployed to a particular region, whether firmware needs to be updated, whether an existing network device needs maintenance, etc. to increase a probability of connecting an emergency call and to increase a probability that the connection will be successful (e.g., to facilitate a communication).

In some embodiments, the one or more processor(s) 308 are central processing units (CPUs), graphics processing units (GPUs), or both CPU and GPU, or other processing units or components known in the art.

The centralized server 300 also includes additional data storage devices (removable and/or non-removable) such as, for example, magnetic disks, optical disks, or tape. Such additional storage is illustrated in FIG. 3 by removable storage 310 and non-removable storage 312. Tangible computer-readable media can include volatile and nonvolatile, removable and non-removable media implemented in any method or technology for storage of information, such as computer readable instructions, data structures, program modules, or other data. Memory 302, removable storage 310 and non-removable storage 312 are all examples of computer-readable storage media, as described above in connection with FIG. 2.

The centralized server 300 also can include input device(s) 314, such as a keypad, a cursor control, a touch-sensitive display, voice input device, etc., and output device(s) 316 such as a display, speakers, printers, haptic feedback, etc. These devices are well known in the art and need not be discussed at length here.

As illustrated in FIG. 3, the centralized server 300 also includes one or more wired or wireless transceiver(s) 318, similar to the transceiver(s) 218 described above in connection with FIG. 2.

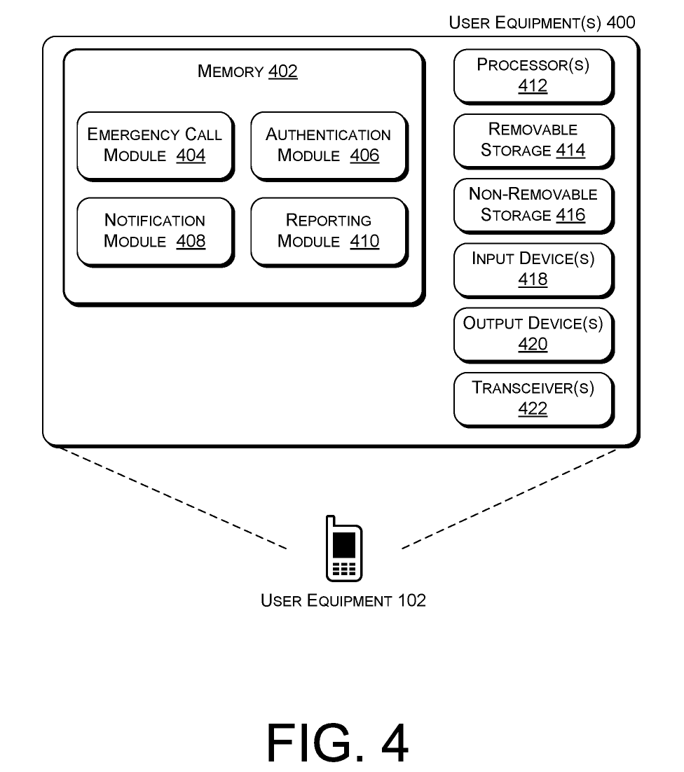

FIG. 4 illustrates an example user equipment 400 for initiating an emergency call via the open access points of the present disclosure. In some embodiments, the user equipment 400 can correspond to the user equipment 102 of FIG. 1, and may be used to implement the various operations described herein. In some instances, user equipment may include, and is not limited to, one or more servers, smart phones, mobile phones, cell phones, tablet computers, portable computers, laptop computers, personal digital assistants (PDAs), electronic book devices, or any other electronic devices that can generate, request, receive, transmit, or exchange voice, video, and/or digital data. For example, the user equipment 400 may include memory 402 storing an emergency call module 404, an authentication module 406, a notification module 408, and a reporting module 410, as described herein. Also, the user equipment 400 includes processor(s) 412, a removable storage 414 and non-removable storage 416, input device(s) 418, output device(s) 420, and transceiver(s) 422.

In various embodiments, memory 402 is volatile (such as RAM), non-volatile (such as ROM, flash memory, etc.) or some combination of the two. The emergency call module 404, the authentication module 406, the notification module 408, and the reporting module 410 stored in the memory 402 can comprise methods, threads, processes, applications or any other sort of executable instructions. The emergency call module 404, the authentication module 406, the notification module 408, and the reporting module 410 can also include files and databases.

In some embodiments, the emergency call module 404 can include functionality to attempt to initiate a communication with an access point based on an availability of communication protocols, for example. That is, the emergency call module 404 can include a priority of calling, such that the module 404 may attempt to establish a communication with a base station (e.g., such as a 2G, 3 G, 4G, or LTE base station, such as the base station 104 of FIG. 1). In the absence of a network where the user equipment 400 is authorized to access (e.g., via a password, passcode, encryption key, subscription, contract, etc.), the emergency call module 404 may attempt to establish a communication with a private access point (e.g., the access point 114) using the open access functionality as described herein. In some instances, if a connection to an open base station (e.g., the base station 104) is available and a connection to a private access point (e.g., the access point 114) is also available, the emergency call module 404 may attempt to establish an emergency call based at least in part on a Quality of Service (QoS) or Received Signal Strength Indication (RSSI) associated with each signal. For example, the emergency call module 404 may attempt to initiate a communication via a strongest signal. In some instances, the emergency call module 404 may attempt to establish a communication in serial according to a priority of connections, and in some instances, the emergency call module 404 may attempt to establish a communication in parallel with some or all available connections, while later selecting one connection to ultimately provide access to a PSAP, for example.

In some embodiments, the authentication module 406 can include functionality to provide one or more credentials associated with the user equipment 400 to an access point and/or to a centralized server. For example, user equipment 400 may provide credentials to the access point in conjunction with a request for resources (e.g., a channel, timeslot, etc.) to make an emergency call. In some instances, in response to a request for resources, the access point and/or the centralized server may transmit a request to the user equipment. In any event, credentials may include, but are not limited to, telephone numbers, MAC addresses, email addresses, IMEI numbers, SIM card identities, encryption keys, etc., associated with the user equipment 400. In response to providing one or more credentials, the user equipment 400 may selectively be granted no access, partial network access (e.g., emergency access only, limited bandwidth, limited to one of voice or data, etc.), or full network access (e.g., unrestricted voice/data connections to any source), as described herein. In some embodiments, the authentication module 406 may include functionality to format a request for an emergency call to include a flag, token, and/or field indicating that the request is directed to an emergency call, which may implement the communication operations, as described herein.

In some embodiments, the notification module 408 can include functionality to provide one or more indications via the user equipment regarding a status of an interaction with an access point, as described herein. For example, the notification module 408 may provide one or more of visual, audio, and/or haptic feedback to indicate to a user a status of a network connection. In some instances, the notification module 408 may provide a notification that an emergency call is being made through an open access point and that network connectivity is limited to an emergency call. In some instances, the notification module 408 can provide a notification that a base station (e.g., the base station 104) is unavailable and that only emergency calls are available through an open access point (e.g., the access point 114) as described herein.

In some embodiments, the reporting module 410 can include functionality to provide reports and/or historical call data of emergency calls from user equipment to optimize the emergency call modules and/or emergency access modules as discussed herein. For example, after each emergency call is placed, user equipment can provide a log of some or all activity associated with the emergency call, including location of the user equipment (or whether location information was available or not available), QoS of network(s), call flows (e.g., order of initiating a communication with networks, timeouts, retries, success/failure of connections, etc.) to a centralized server (e.g., the centralized server 300).

In some embodiments, the one or more processor(s) 412 are central processing units (CPUs), graphics processing units (GPUs), or both CPU and GPU, or other processing units or components known in the art.

The user equipment 400 also includes additional data storage devices (removable and/or non-removable) such as, for example, magnetic disks, optical disks, or tape. Such additional storage is illustrated in FIG. 4 by removable storage 414 and non-removable storage 416. Tangible computer-readable media can include volatile and nonvolatile, removable and non-removable media implemented in any method or technology for storage of information, such as computer readable instructions, data structures, program modules, or other data. Memory 402, removable storage 414 and non-removable storage 416 are all examples of computer-readable storage media, as described above in connection with FIG. 2.

The user equipment 400 also can include input device(s) 418, such as a keypad, a cursor control, a touch-sensitive display, voice input device, etc., and output device(s) 420 such as a display, speakers, haptic feedback, printers, etc. These devices are well known in the art and need not be discussed at length here.

As illustrated in FIG. 4, the user equipment 400 also includes one or more wired or wireless transceiver(s) 422, similar to the transceiver(s) 218 described above in connection with FIG. 2.

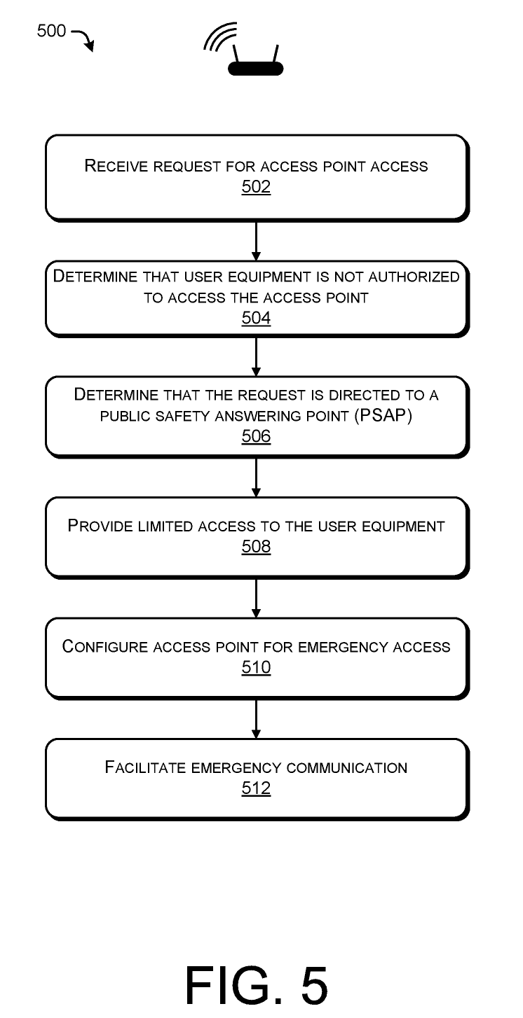

FIGS. 5-7 illustrate example processes in accordance with embodiments of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 5 illustrates an example process 500 for providing an open access point for emergency calls. The example process 500 can be performed by an access point (e.g., the access point 114 or 200), for example. Further, some or all of the process 500 can be performed by one or more components in the environment 100.

At 502, the operation can include receiving a request for access point access. For example, the operation 502 can include receiving a request from a user equipment to establish a communication with a network. In some instances, the request may include a request for voice and/or data services. In some instances, the request may include a query to determine whether the access point is protected by a passcode or encryption, for example. In some instances, the request can include a flag, token, or field indicating that the request is directed to an emergency call.

At 504, the operation can include determining that the user equipment is not authorized to access the access point. For example, the operation 504 can include determining that the request in the operation 502 did not include a correct password, passcode, passphrase, encryption key, etc. In some instances, the operation 504 can include comparing a stored authentication key on the access point with information contained in the request to determine that the user equipment is not authorized to access the access point. In some instances, the operation 504 can include transmitting an indication to the requesting user equipment that the request for access is denied. In some instances, such as when a request includes a flag, token, or field indicating the request is directed to an emergency call, some or all of the operation 504 can be omitted to save time and/or reduce processing. In some instances, the operation 504 can be skipped, omitted, or ignored.

At 506, the operation can include determining that the request is directed to or associated with a public-safety answering point (PSAP). For example, the operation 506 can include determining a destination of the request and comparing the destination to a known list of PSAPs. In some instances, the operation 506 can include determining that a format of the request is directed to a PSAP. In some instances, a request may be directed to a particular emergency channel or emergency wireless resource provided by the access point, or the request may directly request emergency resources. In some instances, the operation 506 may include transmitting or relaying the request to a centralized server and requesting that the centralized server provide a determination about whether the request is directed to an emergency call. In some instances, the operation 506 can include determining that the request includes an indication that the request is directed to an emergency call, for example, via a flag, token, and/or field.

At 508, the operation can include providing limited access to the user equipment. For example, based at least on the operation 506 (e.g., determining that the request is directed to an emergency call) the operation 508 can allow the requesting user equipment to communicate with the access point to facilitate the emergency call. In some instances, the operation 508 can include providing one or more wireless resources to the user equipment, or establish a temporary wireless session for the purpose of making a wireless call. In some instances, the operation 508 can include providing a token that expires after a particular time period, such that the user equipment may re-establish a communication with the access point without re-authenticating if the communication is interrupted. In some instances, after the emergency call is terminated or completed (and following a predetermined time period to allow for the user equipment to re-establish communication, for example), a next request for access can be denied, or a determination for an emergency call can be made anew. In some instances, the operation 508 can include providing an indication to the user equipment (e.g., to be presented or displayed by the user equipment) that limited access is provided to the user equipment and/or that no guarantee is provided about a QoS associated with the access point.

At 510, the operation can include configuring the access point for emergency access. For example, the access point may manage pre-existing traffic on the access point to allocate a portion of resources, such as channels, timeslots, bandwidth, priority, etc. for the purpose of facilitating the emergency communication. In some instances, the operation 510 may include establishing a firewall between the emergency call and other traffic on the access point to prevent unauthorized access to other devices connected to the access point. In some instances, the operation 510 may include establishing a filter to monitor traffic associated with the requesting user equipment to determine whether the traffic is, in fact, directed to the public-safety answering point, for example, and is not being redirected to provide unauthorized communications for the user equipment. In some instances, if traffic is address to a destination not authorized or not associated with the emergency call, the traffic or data can be discarded, deleted, stored in a buffer, etc., and/or an indication can be provided to the user equipment that some or all of the data is being filtered, for example.

At 512, the operation can include facilitating the emergency communication. For example, the operation can include requesting a location of the user equipment and providing the location to the PSAP. In some instances, the operation 512 can include proving a location of the access point to the PSAP. In some instances, the operation can include establishing a call log and details of the call (e.g., date, time, duration, initiating identity, destination, amount/type of data transferred, call quality, QoS metrics, etc.) to provide to a centralized server for later analysis.

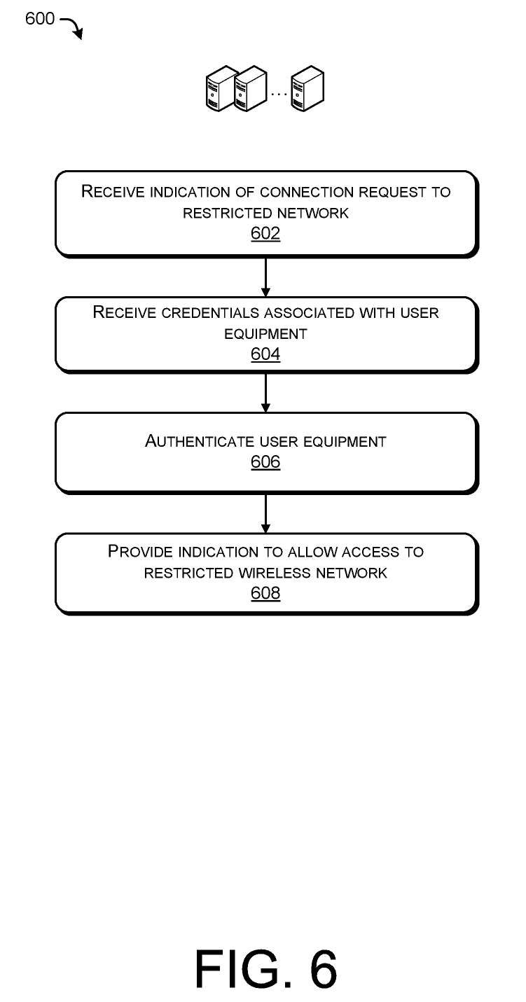

FIG. 6 illustrates an example process 600 for verifying credentials associated with user equipment during an emergency call. The example process 600 can be performed by a centralized server (e.g., the centralized server 110 or 300), for example. Further, some or all of the process 600 can be performed by one or more components in the environment 100.

At 602, the operation can include receiving an indication of a connection request to connect to a restricted network. For example, this operation 602 can include receiving, at a centralized server, an indication, message, or communication from an access point that a user equipment is attempting to establish a communication with the access point without the proper passcode, encryption key, etc. In some instances, the access point can be a private network (e.g., installed in a home or office environment) that provides access only to authorized devices, as discussed herein.

At 604, the operation can include receiving credentials associated with the user equipment. Further, the operation 604 may also include transmitting a request to the user equipment for credentials. In some instances, the credentials may include a telephone number, a SIM identity, a MAC address, an IP address, and email address, biometric data (e.g., fingerprint, voice data), image data (e.g., representing a user, for image analysis such as facial recognition), IMEI number, etc.

At 606, the operation can include authenticating the user equipment. In some instances, the authenticating can be based at least in part on the credentials received in the operation 606. In some instances, the operation 606 may include comparing the received credentials against one or more entries in a database to determine if the credentials refer to a user equipment or a user profile associated with a subscription, contract, service provider, network provider, etc. In some instances, the operation 606 may further include authenticating a destination of the connection request (e.g., the destination for an emergency call) to determine that the call is, in fact, directed to an emergency call. In some instances, authenticating a destination of a call may be performed in addition to, or instead of the operations to authenticate user equipment, for example.

At 608, the operation can include providing an indication to allow access to the restricted network. For example, the centralized server can transmit an instruction or message to the access point to instruct the access point to provide access to the user equipment initiating a communication. In some instances, the indication may instruct the access point to provide unrestricted access to the user equipment (e.g., not limited by bandwidth, destination, privileges, etc.), while in some instances, the indication may instruct the access point to provide limited access to the user equipment (e.g., access limited by time, duration, destination, bandwidth, etc.). In some instances, the centralized server may selectively provide access (and/or levels of access) based on a contractual relationship or subscription that the user equipment has established with other entities.

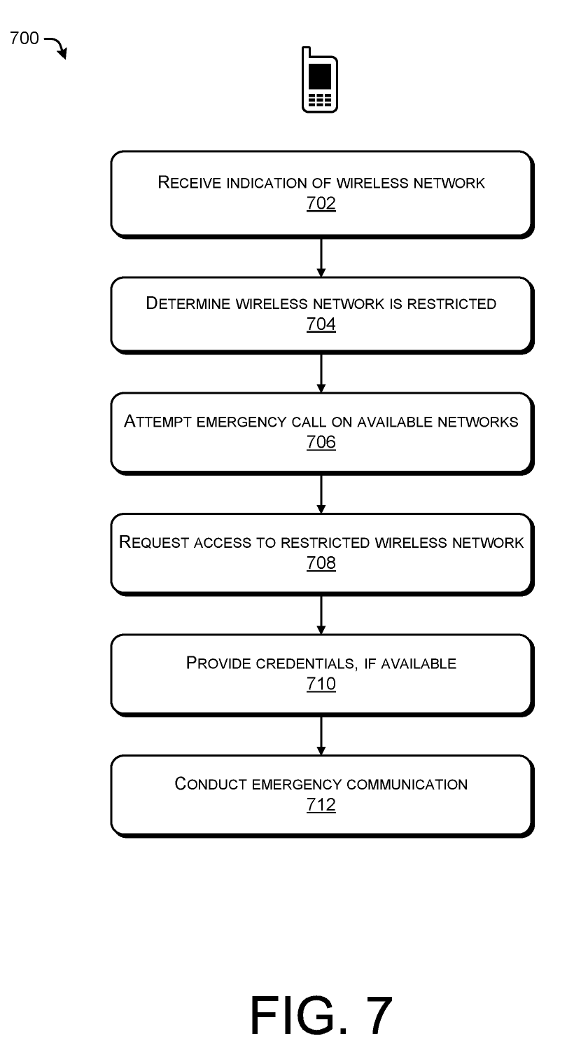

FIG. 7 illustrates an example process 700 for establishing an emergency call on an open access point in accordance with the present disclosure. The example process 700 can be performed by a user equipment (e.g., the user equipment 102 or 400), for example. Further, some or all of the process 700 can be performed by one or more components in the environment 100.

At 702, the operation can include receiving an indication of a wireless network. For example, the operation 702 may include the user equipment scanning for available wireless networks, such as a base stations, authorized access points, private access points, etc. In some instances, the operation 702 may include requesting capabilities of the wireless networks and/or requesting preconditions or rules associated with the network to establish a communication.

At 704, the operation can include determining that a wireless network is restricted. For example, the operation may include receiving an indication from the wireless network (e.g., the access point 114) that the wireless network is restricted and that the user equipment is not authorized to communicate on the network. In some instances, the operation 704 may include receiving a failure notice that the user equipment cannot establish a communication or is not authorized to communicate via the wireless network. In some instances, the operation 704 can include determining that the access point is restricted but for an agreement to follow terms and/or conditions established by the access point. For example, a user may agree with terms and/or conditions indicated on a display before using the access point. In such an event, the process 700 may include automatically accepting such terms and/or conditions to make an emergency call.

At 706, the operation can include attempting an emergency call on available networks. For example, the user equipment can attempt to establish an emergency call based on a priority of networks associated with the user equipment (e.g., a first priority network being a default network or a network that the user equipment is subscribed to, a priority based on call strength, access levels, etc.). In some instances, the operation 706 may include initiating communication with a plurality of wireless networks in parallel.

At 708, the operation can include requesting access to the restricted wireless network. For example, the operation may include transmitting an express indication that the request is directed to an emergency call, such as a flag, token, or field. In some instances, the request can include an address or destination associated with an emergency call, such as a PSAP. In some instances, the operation 708 can include retrying an initiation protocol to request services.

At 710, the operation can include providing credentials of the user or the user equipment to the access point and/or the centralized server, if available. Examples of credentials include, but are not limited to, one or more of a telephone number, MAC address, IMEI number, etc., as discussed herein. In some instances, the user equipment may not have credentials stored on or associated with the user equipment.

At 712, the operation can include conducting an emergency communication via the open access point as discussed herein. In some instances, the operation 712 may include providing voice and/or data packets to the access point in accordance with a configuration established by the access point (e.g., according to a bandwidth, format, destination, etc. established by the access point). Thus, the operations described herein allow an unauthorized user equipment to gain limited access to a protected access point to conduct an emergency call.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A device comprising:
one or more processors; and
a memory storing computer-executable instructions that, when executed by the one or more processors, cause the one or more processors to perform operations comprising:
receiving a request from a user equipment to access at least one wireless resource provided by the device;
determining that the user equipment is not authorized to access the at least one wireless resource provided by the device;
determining that a first destination associated with the request is directed to a public-safety answering point (PSAP);
configuring the device to provide the at least one wireless resource to the user equipment;
facilitating an emergency communication between at least the user equipment and the PSAP;
determining that the user equipment is also transmitting data addressed to a second destination not associated with the PSAP; and
discarding the data addressed to the second destination without forwarding the data to the second destination.

2. The device of claim 1, wherein configuring the device to provide the at least one wireless resource to the user equipment includes allocating a minimum bandwidth to the user equipment to conduct the emergency communication.

3. The device of claim 1, the operations further comprising:
requesting at least one credential from the user equipment, the at least one credential associated with a valid identity of the user equipment;
receiving the at least one credential from the user equipment;
transmitting a first indication of the at least one credential to a centralized server; and
receiving a second indication from the centralized server that the user equipment is authenticated, the second indication based at least in part on the first indication of the at least one credential.

4. (canceled)

5. A system comprising:
one or more processors; and
a memory storing computer-executable instructions that, when executed by the one or more processors, cause the one or more processors to perform operations comprising:
receiving a first request for at least one wireless resource;
determining that a user equipment requesting the at least one wireless resource is not authorized to access the at least one wireless resource;
determining that the first request is associated with an emergency call;
providing the at least one wireless resource to the user equipment based at least in part on the first request being associated with the emergency call;
transmitting data associated with the emergency call via the at least one wireless resource;
receiving a second request for the at least one wireless resource from the user equipment;
determining that the second request is not associated with an emergency call; and
providing an indication to the user equipment that the user equipment is not authorized to access the at least one wireless resource.

6. (canceled)

7. The system of claim 5, the operations further comprising configuring an access point to provide the at least one wireless resource to the user equipment, wherein the configuring includes at least establishing a single wireless session enabling the user equipment to conduct the emergency call.

8. The system of claim 7, the operations further comprising limiting a destination of the emergency call to one or more destinations associated with one or more public-safety answering points.

9. The system of claim 5, wherein determining that the first request is associated with an emergency call includes at least transmitting a first indication of the emergency call to a centralized server and receiving a confirmation from the centralized server that the emergency call is a valid emergency call.

10. The system of claim 5, the operations further comprising:
determining that the emergency call is completed; and
restricting access of the user equipment to the at least one wireless resource.

11. The system of claim 10, wherein the at least one wireless resource is a Wi-Fi resource, and wherein authorizing the Wi-Fi resource is based at least in part on at least one of a Wired Equivalent Privacy (WEP) protocol or a Wi-Fi Protected Access (WPA) protocol.

12. The system of claim 5, the operations further comprising:
transmitting a third request to the user equipment for a location associated with the user equipment;
receiving an indication of the location of the user equipment; and
transmitting the indication of the location of the user equipment to a public-safety answering point.

13. The system of claim 5, the operations further comprising:
requesting at least one credential from the user equipment;
receiving the at least one credential from the user;
transmitting a first indication of the at least one credential to a centralized server; and
receiving a second indication from the centralized server that the user equipment is authenticated based at least in part on a contractual relationship between the user equipment and the centralized server, the second indication based at least in part on the first indication of the at least one credential.

14. A processor-implemented method comprising:
receiving a first request for at least one wireless resource;
determining that a user equipment requesting the at least one wireless resource is not authorized to access the at least one wireless resource;
determining that the first request is associated with an emergency call;
providing the at least one wireless resource to the user equipment based at least in part on the first request being associated with the emergency call;
transmitting data associated with the emergency call via the at least one wireless resource;
receiving a second request for the at least one wireless resource from the user equipment;
determining that the second request is not associated with an emergency call; and
providing an indication to the user equipment that the user equipment is not authorized to access the at least one wireless resource.

15. (canceled)

16. The processor-implemented method of claim 14, further comprising configuring an access point to provide the at least one wireless resource to the user equipment, wherein the configuring includes at least establishing a single wireless session enabling the user equipment to conduct an emergency call.

17. The processor-implemented method of claim 14, further comprising limiting a destination of the emergency call to one or more destinations associated with one or more public-safety answering points.

18. The processor-implemented method of claim 14, wherein determining that the first request is associated with an emergency call includes at least transmitting a first indication of the emergency call to a centralized server and receiving a confirmation from the centralized server that the emergency call is a valid emergency call.

19. The processor-implemented method of claim 14, further comprising:
determining that the emergency call is completed; and
restricting access of the user equipment to the at least one wireless resource.

20. The processor-implemented method of claim 14, further comprising:
requesting at least one credential from the user equipment;
receiving the at least one credential from the user;
transmitting a first indication of the at least one credential to a centralized server; and
receiving a second indication from the centralized server that the user equipment is authenticated based at least in part on a contractual relationship between the user equipment and the centralized server, the second indication based at least in part on the first indication of the at least one credential.
